(19) United States
(12) Patent Application Publication
(10) Pub. No.: US 2006/0059801 A1
(43) Pub. Date: Mar. 23, 2006

(54) Acoustically intelligent structures with resonators

(75) Inventor: Daryoush Allaei, Minnetonka, MN (US)

Correspondence Address: Leffert Jay & Polglaze, P.A., P.O. Box 581009, Minneapolis, MN, 55458-1009, US

(73) Assignee: Quality Research Development & Consulting, Inc.

(21) Appl. No.: 10/941,434

(22) Filed: Sep. 15, 2004

(51) Int. Cl. E06B 3/00

(52) U.S. Cl. 52/204.5

(57) ABSTRACT

Methods and apparatus are provided. A structure has one or more first resonators for absorbing noise having a first frequency substantially the same as a resonant frequency of the one or more first resonators. The resonant frequency of each of the one or more first resonators may be adjusted by adjusting a size of an opening and/or a volume of that first resonator. The size of the opening and/or the volume may be manually adjusted or may be adjusted by a controller in response to a noise monitor. One or more second resonators may also be included for absorbing noise having a second frequency substantially the same as a resonant frequency of the one or more second resonators.

### TECHNICAL FIELD OF THE INVENTION

The present invention relates generally to noise and acoustic control and in particular the present invention relates to acoustically intelligent structures with resonators.

### BACKGROUND OF THE INVENTION

Noise pollution is an ever-increasing problem. Noise from automobiles, airplanes, trains, power equipment, animals, electronics and computers in office areas or homes, etc. passes though the walls and windows of spaces used for human occupation or living, such as workplaces, homes, schools, churches, and various shelters. The noise interferes with our ability to hear, sleep, perform, may cause fatigue, etc. Noise insulation has been used in walls to mitigate noise transmission, but often targets a rather small range of noise frequencies.

One technique for reducing noise transmission through a window involves a double-paned window with each of the panes having a different thickness for blocking out noise over a broader range of frequencies than two-paned windows with panes having the same thickness. Another technique involves a two-paned window with each of the panes having a different density for blocking out noise over a broader range of frequencies than two-paned windows with panes having the same density. For some techniques, a vibration dampening material is disposed between two windowpanes of different thickness and/or density for dampening vibrations of either windowpane. One problem with these techniques for reducing sound transmission through windows is that they usually require increased frame sizes and more glass compared to conventional two-paned windows, which results in increased costs. Also, these techniques may result in relatively heavier windows and thus may be more difficult to install than conventional windows. Moreover, these techniques are limited to two-paned windows. Depending on the required acoustic property of a window, the cost of that window may increase by 30% to 60% when compared to non-acoustic windows.

Another technique for reducing sound transmission through a window involves laminated windowpanes for reducing sound transmission. However, laminated windowpanes are more expensive than non-laminated windows, e.g., usually about 30 to 60 percent more expensive. Moreover, laminated windows and two-paned windows having panes of different density may alter optical properties of the window.

For the reasons stated above, and for other reasons stated below which will become apparent to those skilled in the art upon reading and understanding the present specification, there is a need in the art for alternative noise reduction methods.

### SUMMARY

The above-mentioned problems with noise reduction and other problems are addressed by the present invention and will be understood by reading and studying the following specification.

Embodiments of the invention provide structures, such as walls, furniture, windows, etc., that have one or more resonators, e.g., Helmholtz resonators, for absorbing noise at their resonant frequencies.

One embodiment of the invention provides a wall having a plurality of structural elements. One or more structural elements of the plurality of structural elements have a resonator therein. The resonator has an opening. The one or more first structural elements include an adjustable shutter for varying a size of the opening.

Another embodiment of the invention provides a window having a frame, one or more windowpanes disposed within the frame, and one or more resonators connected to the frame.

Another embodiment of the invention provides a table having a top with one or more resonators and a plurality of legs connected to the top.

Another embodiment of the invention provides a rack having a plurality of posts. One or more of the posts include a resonator. Two or more shelves are connected to the plurality of posts.

Another embodiment of the invention provides a chair having a seat, a back connected to the seat, and one or more resonators connected to either the seat or the back.

Another embodiment of the invention provides a bookcase with a frame having one or more resonators. A book container is connected to the frame.

Another embodiment of the invention provides a noise reduction method that includes receiving noise at a monitor, transmitting a signal representative of the noise to a controller, and adjusting a resonant frequency of one or more first resonators of a structure to a frequency of the noise using the controller in response to receiving the signal at the controller.

Further embodiments of the invention include methods and apparatus of varying scope.

### BRIEF DESCRIPTION OF THE DRAWINGS

FIG. 1A illustrates a structure, according to an embodiment of the invention.

FIG. 1B illustrates a resonator, according to another embodiment of the invention.

FIG. 2 illustrates a chair, according to another embodiment of the invention.

FIG. 3 illustrates a bookcase, according to another embodiment of the invention.

FIG. 4 illustrates a table, according to another embodiment of the invention.

FIG. 5 illustrates a rack, according to another embodiment of the invention.

FIG. 6 illustrates a window, according to another embodiment of the invention.

FIG. 7 illustrates a window, according to yet another embodiment of the invention.

FIG. 8 illustrates a window, according to another embodiment of the invention.

FIG. 9 illustrates a portion of a structure, according to another embodiment of the invention.

FIG. 10 illustrates a resonator, according to another embodiment of the invention.

FIG. 11 illustrates a resonator, according to another embodiment of the invention.

FIG. 12 is a block diagram illustrating a control system, according to another embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

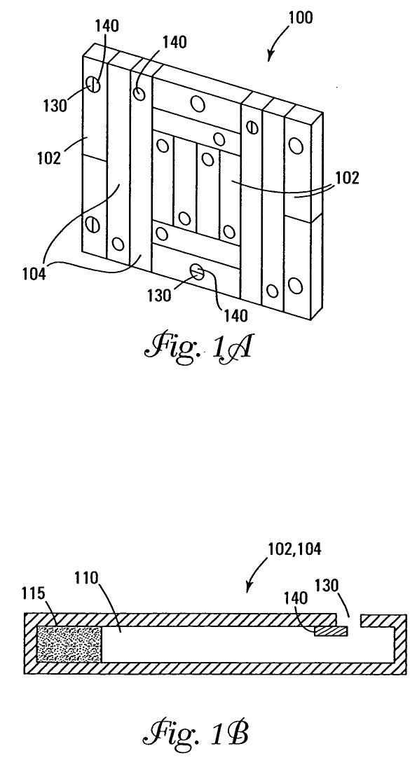

FIG. 1A illustrates a structure 100, such as a wall, a tabletop, a portion of a bookcase, a back and/or seat of a chair, shelves of a rack, etc., according to an embodiment of the present invention. Structure 100 is formed from one or a plurality of structural elements 102 and 104. Each of structural elements 102 and 104 includes a hollow interior 110 (shown in FIG. 1B) communicatively coupled to an exterior of structure 100 by an opening 130 (FIGS. 1A and 1B) so that each of structural elements 102 and 104 acts as a resonator, e.g., a Helmholtz resonator, for absorbing an acoustic energy (or sound or noise) at its resonant frequency. The principle of Helmholtz resonators is well known and will not be detailed herein. However, it suffices to say that the resonant frequency of structural elements 102 and 104 depends of the size (or cross-sectional area) of opening 130 and the volume of hollow interior 110.

For one embodiment, the structural elements 102 and 104 are selected to absorb noises of different frequencies from different noise sources or different harmonics of noise from a single noise source. However, for another embodiment, the structural elements 102 and 104 may be selected to absorb substantially the same noise from a single noise source.

For one embodiment, a size (or cross-sectional area) of opening 130 is adjustable, e.g., using a manually or electro-mechanically actuated shutter 140 (FIGS. 1A and 1B), for tuning the respective resonator. A suitable shutter may include a rotatable flap of the type used for controlling a size of an opening in a butterfly valve, a slidable gate, etc. For another embodiment, each of the resonators produces high impedance to noise propagation at its natural frequency. This acts to block the propagation of incident noise.

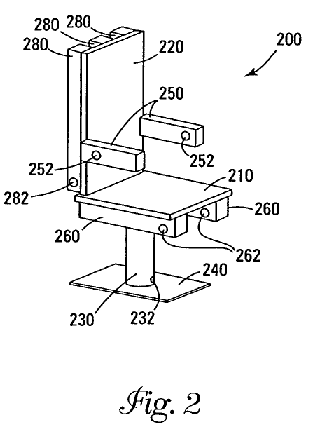

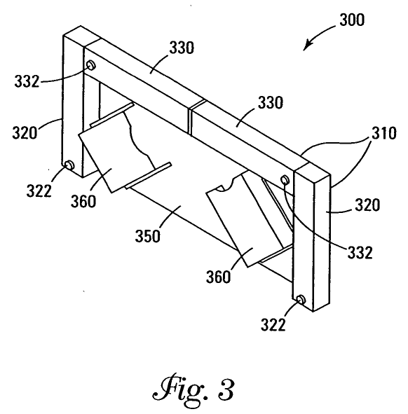

FIG. 2 illustrates a chair 200, according to another embodiment of the invention. Chair 200 includes a seat 210 connected to a back 220 and a leg 230. Leg 230 is connected to a base 240, for one embodiment. Alternatively, for other embodiments, four legs may be connected to seat 210. For one embodiment, chair 200 includes armrests 250 that may be connected to back 220, for another embodiment. For one embodiment, leg 230 includes a hollow portion communicatively coupled to an exterior of chair 200 by an opening 232 and thus functions as a Helmholtz resonator. For embodiments, with four legs, one or more of the legs may be Helmholtz resonators. For some embodiments, each of armrests includes a hollow portion communicatively coupled to an exterior of chair 200 by an opening 252 and thus functions as a Helmholtz resonator.

For other embodiments, Helmholtz resonators 260, each having an opening 262, are connected to seat 210. For another embodiment, Helmholtz resonators 280, each having an opening 282, are connected to back 220. For one embodiment, one or more of openings 232, 252, 262, and 282 are adjustable, e.g., using a manually or electro-mechanically actuated shutter, for tuning the respective resonator. For other embodiments, seat 210 and/or back 220 may be formed from Helmholtz resonators, e.g., as described for structure 100 of FIG. 1. Note that the Helmholtz resonators of chair 200 may be respectively tuned for absorbing noises of different frequencies from different noise sources, different harmonics of noise from a single noise source, substantially the same noise from a single noise source, etc.

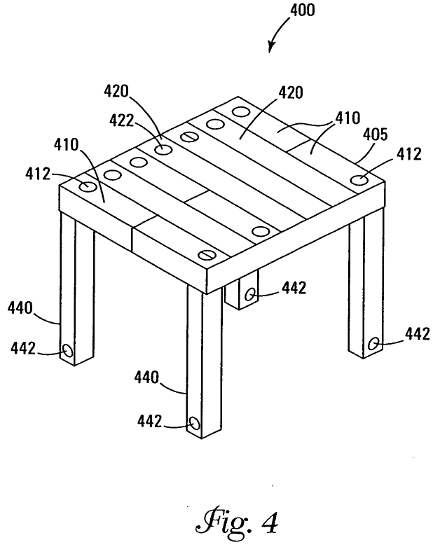

FIG. 3 illustrates a bookcase 300, according to another embodiment of the invention. Bookcase 300 includes a frame 310 formed from Helmholtz resonators 320 and 330 respectively having openings 322 and 332. For one embodiment, one or more of openings 322 and 332 are adjustable, e.g., using a manually or electro-mechanically actuated shutter, for tuning the respective resonator. A plate 350 is connected to frame 310 and may be formed from Helmholtz resonators, for one embodiment, e.g., as described for structure 100 of FIG. 1. Pockets 360 are connected to plate 350 for containing books or the like therein. The Helmholtz resonators of bookcase 300 may be respectively tuned for absorbing noises of different frequencies from different noise sources, different harmonics of noise from a single noise source, substantially the same noise from a single noise source, etc.

FIG. 4 illustrates a table 400, according to another embodiment of the invention. Table 400 includes a top 405 that in one embodiment is formed from one or a plurality of Helmholtz resonators 410 and 420. Legs 440 are connected to top 405. For one embodiment, one or more of legs 440 may be Helmholtz resonators. Openings 412 and 422 respectively of Helmholtz resonators 410 and 420 and openings 442 of legs 440 are adjustable for one embodiment, e.g., using a manually or electro-mechanically actuated shutter, for tuning the respective resonator. The Helmholtz resonators of table 400 may be respectively tuned for absorbing noises of different frequencies from different noise sources, different harmonics of noise from a single noise source, substantially the same noise from a single noise source, etc.

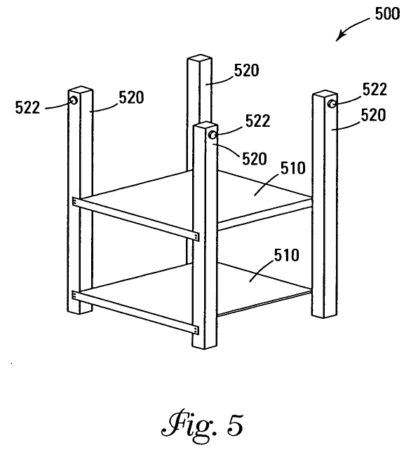

FIG. 5 illustrates a rack 500, according to another embodiment of the invention. Rack 500 has shelves 510 interconnected by support posts 520. For one embodiment, one or more of posts 520 is a Helmholtz resonator and has an opening 522. Openings 522 are adjustable for one embodiment, e.g., using a manually or electro-mechanically actuated shutter, for tuning the respective resonator. For another embodiment, one or more of shelves 510 may be formed from Helmholtz resonators, e.g., as described for structure 100 of FIG. 1. The Helmholtz resonators of rack 500 may be respectively tuned for absorbing noises of different frequencies from different noise sources, different harmonics of noise from a single noise source, substantially the same noise from a single noise source, etc.

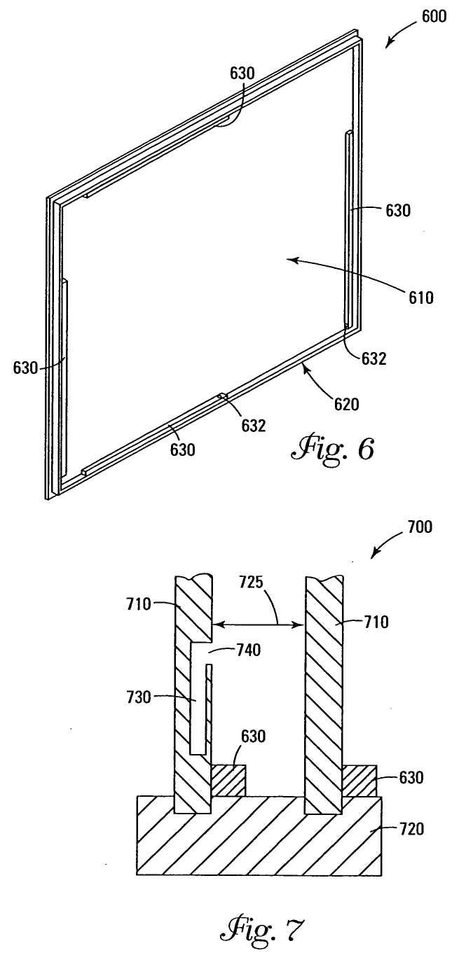

FIG. 6 illustrates a window 600, according to another embodiment of the invention. Window 600 has a windowpane 610 contained within a frame 620. One or more Helmholtz resonators 630, each having an opening 632, are disposed on frame 620 adjacent the windowpane 610. Openings 632 are adjustable for one embodiment, e.g., using a manually or electro-mechanically actuated shutter, for tuning the respective resonator. The Helmholtz resonators of window 600 may be respectively tuned for absorbing noises of different frequencies from different noise sources, different harmonics of noise from a single noise source, substantially the same noise from a single noise source, etc. For another embodiment, frame 620 may be formed from Helmholtz resonators.

FIG. 7 illustrates a window 700 having two or more windowpanes 710 disposed within a frame 720 and spaced apart by a gap 725, according to another embodiment of the invention. For one embodiment, one or more Helmholtz resonators 630 are disposed around frame 720 within gap 725. For another embodiment, one or more Helmholtz resonators 630 are disposed around frame outside of windowpanes 710. For another embodiment, one or more Helmholtz resonators 730, each having an opening 740, e.g., opening into gap 725, may be integrated within at least one of the windowpanes 710, as shown in FIG. 7.

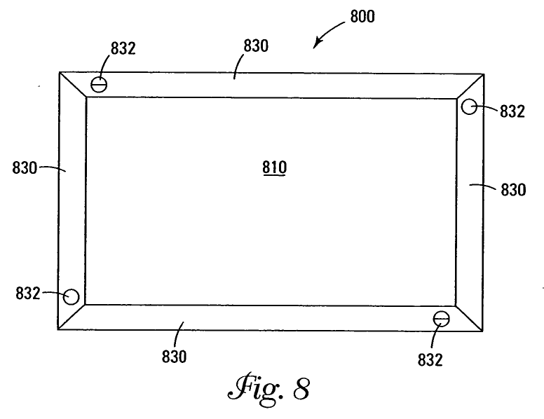

FIG. 8 illustrates a window 800, according to another embodiment of the invention. Window 800 includes a windowpane 810 disposed in a frame formed from one or more Helmholtz resonators 830, each having an opening 832. Openings 832 are adjustable for one embodiment, e.g., using a manually or electro-mechanically actuated shutter, for tuning the respective resonator. The Helmholtz resonators of window 800 may be respectively tuned for absorbing noises of different frequencies from different noise sources, different harmonics of noise from a single noise source, substantially the same noise from a single noise source, etc.

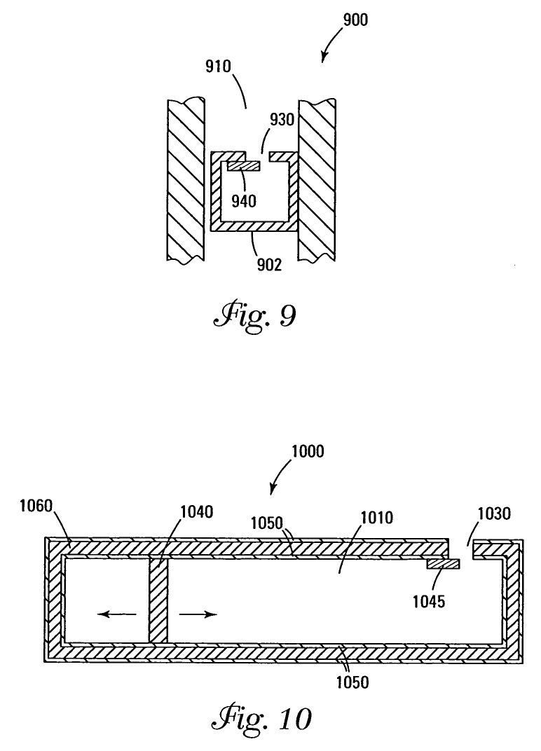

FIG. 9 illustrates a portion of a structure 900, such as a wall, a tabletop, a portion of a bookcase, a back and/or seat of a chair, shelves of a rack, a window frame, etc., according to another embodiment of the invention. For this embodiment, one or more Helmholtz resonators 902 are disposed within a hollow interior 910 of the structure 900. The one or more Helmholtz resonators 902 each have an opening 930 that opens into the hollow interior 910 of the structure 900. For another embodiment, a size (or cross-sectional area) of opening 930 is adjustable, e.g., using a manually or electro-mechanically actuated shutter 940, for tuning the respective resonator 902.

For one embodiment, a damping material, such as damping material 115 of FIG. 1B, may be disposed in one or more of the Helmholtz resonators described above. For one embodiment, the damping material may be a viscoelastic material.

FIG. 10 illustrates a Helmholtz resonator 1000, according to another embodiment of the invention, that can be used for any of the above-described embodiments. Helmholtz resonator 1000 includes a hollow interior 1010 and opening 1030. A movable piston 1040 is disposed within interior 1010 for changing the volume of interior 1010 and thus the resonant frequency of Helmholtz resonator 1000. Piston may be actuated manually or electro-mechanically using an actuator that includes a stepper motor, a solenoid, or the like. For one embodiment, opening 1030 is adjustable, e.g., using a manually or electro-mechanically actuated shutter 1045, for further tuning resonator 1000. For another embodiment, interior and/or exterior surfaces of Helmholtz resonator 1000 are coated with a thin film 1050 of damping material for implementing constrained-layer damping. For another embodiment, the walls 1060 of Helmholtz resonator 1000 are formed from a laminate, such as a laminated metal, for implementing constrained-layer damping.

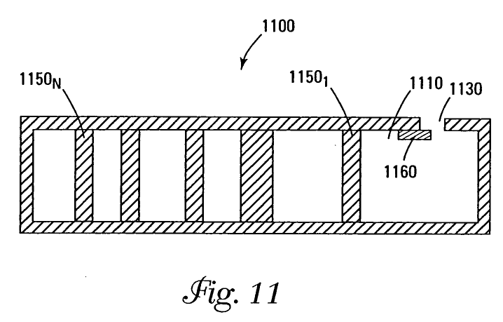

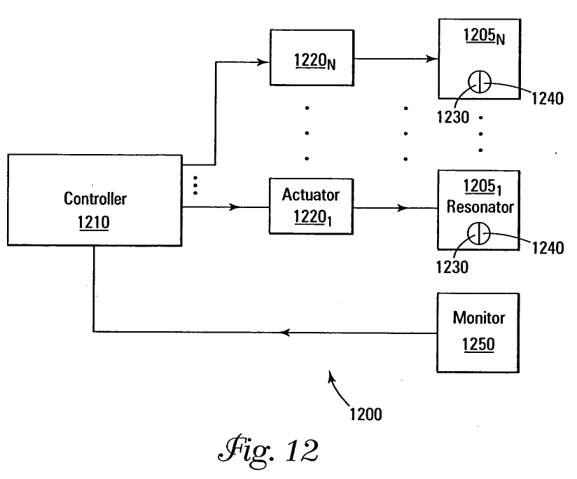

FIG. 11 illustrates a Helmholtz resonator 1100, according to another embodiment of the invention, that can be used for any of the above-described embodiments. Helmholtz resonator 1100 includes a hollow interior 1110 and opening 1130. A plurality of movable partitions 1150 is disposed within interior 1010 for changing the volume of interior 1010 and thus the resonant frequency of Helmholtz resonator 1000. This is accomplished by sequentially removing one or more of partitions 1150, starting with the partition closest to opening 1130, e.g., partition 11501. Note that adding partitions 1150 also can change the volume. Each of partitions 1150 may be removed or added manually or electro-mechanically using an actuator that includes a stepper motor, a solenoid, or the like. For one embodiment, opening 1130 is adjustable, e.g., using a manually or electro-mechanically actuated shutter 1160, for further tuning resonator 1100.

FIG. 12 is a block diagram illustrating a control system 1200 for adjusting an opening size of one or more Helmholtz resonators 1205 and/or for adjusting the internal volume of one or more of Helmholtz resonators 1205 using a piston or by removing or adding partitions, according to another embodiment of the present invention. This adjusts the resonant frequency of the one or more Helmholtz resonators 805 such that the one or more Helmholtz resonators 1205 can absorb incident noise at that frequency. For one embodiment, Helmholtz resonators 1205 may be as described for any of the embodiments described above.

Control system 1200 includes a controller 1210 having an output electrically connected to an input of each of one or more actuators 1220. Each actuator is adapted to vary a geometrical parameter of a respective one of Helmholtz resonators 1205, such as a size of an opening 1230 of that Helmholtz resonator 1205 and/or a volume of that Helmholtz resonator 1205 for varying the resonant frequency of that Helmholtz resonator 1205. Specifically, each actuator 1220 is mechanically coupled to a shutter 1240 of a respective one of Helmholtz resonators 1205 for varying a size of an opening 1230 of that Helmholtz resonator 1205 and/or a piston or one or more partitions for varying a volume of that Helmholtz resonator 1205. Each actuator 1220 may include a stepper motor, a solenoid, or the like, for moving its respective shutter 1240 and/or piston or partitions in response to a control signal from controller 1210. For one embodiment, a monitor 1250, such as a microphone, has an output electrically connected to an input of controller 1210. For one embodiment, monitor 1250 is an integral component of controller 1210. For other embodiments, monitor 1250 may include a plurality of microphones distributed around a space containing one or more of the structures described above.

For one embodiment, controller 1210 respectively sends one or more control signals to the one or more actuators 1220. For one embodiment, each of the one or more actuators 1220 sets the respective one or more Helmholtz resonators 1205 to the same resonant frequency. For another embodiment, actuators 1220 set their respective Helmholtz resonators 1205 to different resonant frequencies, e.g., corresponding to noises of different frequencies from different noise sources or to different harmonics of a single noise from as single noise source. For various embodiments, controller 1210 outputs the control signals in response direct user inputs.

For some embodiments, controller 1210 outputs the control signals in response to monitor 1250. Specifically, for one embodiment, monitor 1250 receives noise and outputs an electrical signal to controller 1210 that is representative of the noise. Controller 1210 evaluates the electrical signal, e.g., by determining one or more peaks respectively corresponding to noise frequencies from a power spectrum of the noise. Controller 1210 instructs the one or more actuators 1220 to adjust their respective Helmholtz resonators 1205 to one or more of these noise frequencies. The process may be repeated to determine whether the one or more noise frequencies have been attenuated and for readjusting resonators 1205, if necessary. For one embodiment, controller 1210 has a look-up table that includes opening sizes and/or resonator volumes tabulated against resonant frequencies of Helmholtz resonators 1205, and controller 1210 enters the table with a resonant frequency and the table outputs an opening size and/or resonator volume in response to that frequency.

If there is more than one peak in the power spectrum, e.g., first and second peaks respectively corresponding to first and second noise frequencies, one or more Helmholtz resonators 1205 are set to the first frequency and one or more Helmholtz resonators 1205 are set to the second frequency. The process is repeated to determine whether the first and second frequencies have been attenuated and for readjusting the resonators, if necessary.

### CONCLUSION

Embodiments of the invention provide structures, such as walls, furniture, windows, etc., that have one or more resonators, e.g., Helmholtz resonators, for absorbing noise at their resonant frequencies. For one embodiment, a structure has one or more first resonators for absorbing noise having a first frequency substantially the same as a resonant frequency of the one or more first resonators. The resonant frequency of each of the one or more first resonators may be adjusted by adjusting a size of an opening and/or a volume of that first resonator. The size of the opening and/or the volume may be manually controlled or may be controlled by a controller in response to a noise monitor. One or more second resonators may also be included for absorbing noise having a second frequency substantially the same as a resonant frequency of the one or more second resonators.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A window comprising:
a frame;
one or more windowpanes disposed within the frame; and
one or more first resonators connected to the frame.

2. The window of claim 1, wherein each of the one or more first resonators further comprises a shutter for adjusting a size of an opening thereof.

3. The window of claim 2, wherein the shutter is manually adjustable.

4. The window of claim 1, and further comprising a control system adapted to adjust a resonant frequency of the one or more first resonators.

5. The window of claim 4, wherein the control system is responsive to a noise monitor connected thereto.

6. The window of claim 1, and further comprising one or more second resonators connected to the frame, wherein the one or more first resonators and the one or more second resonators have different resonant frequencies.

7. The window of claim 1, wherein the one or more first resonators comprise a damping material.

8. The window of claim 1, wherein the one or more first resonators are selected from the group consisting of being integrated within at least one of the one or more windowpanes, integrated within the frame, and disposed on the frame.

9. The window of claim 1, wherein the one or more first resonators comprise a movable piston or one or more removable partitions for varying an internal volume of the one or more first resonators.

10. A window comprising:
a frame;
one or more windowpanes disposed within the frame;
one or more resonators connected to the frame;
an actuator adapted to adjust a size of an opening or a volume of each of the one or more resonators; and
a controller adapted to control the actuator.

11. The window of claim 10, and further comprising a noise monitor connected to the controller.

12. The window of claim 10, wherein each of the one or more resonators comprises an adjustable shutter that is adjusted by the actuator to adjust the size of the opening of that resonator.

13. The window of claim 10, wherein each of the one or more resonators comprises a movable piston that is moved by the actuator to adjust the volume of that resonator.

14. The window of claim 10, wherein each of the one or more resonators comprises one or more removable partitions that are removed by the actuator to adjust the volume of that resonator.

15. The window of claim 10, wherein the one or more resonators are selected from the group consisting of being integrated within at least one of the one or more windowpanes, integrated within the frame, and disposed on the frame.

16. The window of claim 10, wherein the one or more resonators comprise a damping material.

17. A noise reduction method, comprising:
absorbing noise having a first frequency using a first resonator of a window,
wherein the first resonator has a resonant frequency substantially the same as the first frequency.

18. The method of claim 17, wherein absorbing noise having a first frequency comprises adjusting a size of an opening or an internal volume of the first resonator to set the resonant frequency of the first resonator.

19. The method of claim 18, wherein adjusting a size of an opening or an internal volume of the first resonator comprises using an actuator connected to a controller.

20. The method of claim 19, wherein adjusting the size of the opening or the internal volume is performed in response to a noise monitor connected to the controller.

21. The method of claim 17, and further comprising absorbing noise having a second frequency using a second resonator of the window, wherein the second resonator has a resonant frequency substantially the same as the second frequency.

22. The method of claim 21, wherein absorbing noise having a second frequency comprises adjusting a size of an opening or an internal volume of the second resonator to set the resonant frequency of the second resonator.

23. A noise reduction method, comprising:
receiving noise at a monitor;
transmitting a first signal representative of the noise to a controller; and
adjusting a resonant frequency of one or more first resonators of a structure to a first frequency of the noise using the controller in response to receiving the signal at the controller.

24. The method of claim 23, and further comprising evaluating the first signal at the controller before adjusting the resonant frequency.

25. The method of claim 24, wherein evaluating the first signal at the controller comprises determining a power spectrum of the noise.

26. The method of claim 25, wherein the first frequency of the noise corresponds to a peak in the power spectrum.

27. The method of claim 26, and further comprising adjusting a resonant frequency of one or more second resonators of the structure to a second frequency of the noise using the controller.

28. The method of claim 27, wherein the second frequency of the noise corresponds to another peak in the power spectrum.

29. The method of claim 23, wherein adjusting a resonant frequency of one or more first resonators of a structure comprises adjusting a size of an opening or an internal volume of the one or more first resonators.

30. The method of claim 29, wherein adjusting a size of an opening or an internal volume of the one or more first resonators comprises using an actuator connected to the controller.

31. The method of claim 23, wherein the structure is selected from the group consisting of a wall, window, table, rack, bookcase, and chair.

32. A wall comprising:
a plurality of structural elements, one or more first structural elements of the plurality of structural elements comprising a first resonator therein, the first resonator having an opening, the one or more first structural elements comprising an adjustable shutter for varying the size of the opening.

33. A wall comprising:
structural elements, one or more of the structural elements comprising a resonator, the resonator having an opening, the one or more of the structural elements comprising an adjustable shutter for varying the size of the opening;
an actuator adapted to adjust the shutter; and
a controller adapted to control the actuator.

34. A wall comprising:
a plurality of structural elements, one or more of the plurality of structural elements comprising a resonator therein, the resonator having a movable piston or one or more removable partitions for adjusting an internal volume of the resonator.

35. A table comprising:
a top comprising one or more first resonators; and
a plurality of legs connected to the top.

36. A table comprising:
a top comprising one or more first resonators;
an actuator adapted to adjust a size of an opening or a volume of each of the one or more first resonators;
a controller adapted to control the actuator; and
a plurality of legs connected to the top.

37. A rack comprising:
a plurality of posts, one or more first posts of the plurality of posts comprising a first resonator; and
two or more shelves connected to the plurality of posts.

38. A rack comprising:
a plurality of posts, one or more first posts of the plurality of posts comprising a first resonator;
an actuator adapted to adjust a size of an opening or a volume of the first resonator;
a controller adapted to control the actuator; and
two or more shelves connected to the plurality of posts.

39. A rack comprising:
a plurality of posts; and
two or more shelves connected to the plurality of posts at least one of the shelves comprising one or more first resonators.

40. A rack comprising:
a plurality of posts; and
two or more shelves connected to the plurality of posts at least one of the shelves comprising one or more first resonators;
an actuator adapted to adjust a size of an opening or a volume of each of the one or more first resonators; and
a controller adapted to control the actuator.

41. A chair comprising:
a seat;
a back connected to the seat; and
one or more first resonators connected to either the seat or the back.

42. A chair comprising:
a seat;
a back connected to the seat; and
one or more first resonators connected to either the seat or the back;
an actuator adapted to adjust a size of an opening or a volume of each of the one or more first resonators; and
a controller adapted to control the actuator.

43. A bookcase comprising:
a frame comprising one or more first resonators; and
a book container connected to the frame.

44. A bookcase comprising:
a frame comprising one or more resonators;
an actuator adapted to adjust a size of an opening or a volume of each of the one or more resonators;
a controller adapted to control the actuator; and
a book container connected to the frame.

45. A noise reduction method, comprising:
absorbing noise having a first frequency using a first resonator of a frame of a bookcase, wherein the first resonator has a resonant frequency substantially the same as the first frequency.

46. A noise reduction method, comprising:
absorbing noise having a first frequency using a first resonator of a chair, wherein the first resonator has a resonant frequency substantially the same as the first frequency.

47. A noise reduction method, comprising:
absorbing noise having a first frequency using a first resonator of a rack, wherein the first resonator has a resonant frequency substantially the same as the first frequency.

48. A noise reduction method, comprising:
absorbing noise having a first frequency using a first resonator of a tabletop connected to a plurality of legs, wherein the first resonator has a resonant frequency substantially the same as the first frequency.
